(19) United States
(12) Patent Application Publication
(10) Pub. No.: US 2024/0329309 A1
(43) Pub. Date: Oct. 3, 2024

(54) OPTICAL WAVEGUIDE AND OPTICAL INTEGRATED DEVICE

(71) Applicant: AGC Inc., Tokyo (JP)

(72) Inventor: Seiki OHARA, Tokyo (JP)

(73) Assignee: AGC Inc., Tokyo (JP)

(21) Appl. No.: 18/616,299

(22) Filed: Mar. 26, 2024

(30) Foreign Application Priority Data
Mar. 29, 2023 (JP) 2023-054148

(51) Int. Cl. G02B 6/125; G02B 6/24

(52) U.S. Cl. CPC G02B 6/125; G02B 6/241

(57) ABSTRACT

The present invention relates to an optical waveguide including two or more cores and a cladding portion, in which each of the cores is a continuous portion without branching from a start end to a terminal end in a propagation direction of light, at least one of the cores includes a linear region and a curved region, and has an axis deviation at least at one of a joint between the linear region and the curved region and an inflection point of the curved region, and the axis deviation occurs in a direction perpendicular to the propagation direction of light in a plan view.

### CROSS-REFERENCE TO RELATED APPLICATIONS

This application is based on and claims priority under 35 USC 119 from Japanese Patent Application No. 2023-054148 filed on Mar. 29, 2023, the contents of which are incorporated herein by reference.

### TECHNICAL FIELD

The present invention relates to an optical waveguide and an optical integrated device using the optical waveguide.

### BACKGROUND ART

Silicon photonics, which is a technology of integrating a silicon optical circuit on a silicon chip, is attracting attention. As for silicon photonics, for example, Patent Literature 1 discloses, as an optical waveguide that transmits an optical signal between a silicon optical waveguide formed in an optical integrated circuit and an optical fiber, a polymer optical waveguide that uses adiabatic coupling. This can reduce connection loss with the silicon optical waveguide and the optical fiber and propagation loss of light.
Patent Literature 1: JP2021-511538A

### SUMMARY OF INVENTION

In silicon photonics, chips or boards are connected by fibers, and an optical waveguide can be applied as an interface that connects a silicon optical waveguide and a fiber. In the optical waveguide, one end of a core through which light propagates is connected to the silicon optical waveguide, and the other end is connected to the fiber. In this case, a preferred core width of the core connected to the silicon optical waveguide may be different from a preferred core width of the core connected to the fiber.

On the other hand, for the purpose of increasing the integration of the optical circuit and the like, it has been studied to provide a plurality of cores through which light propagates in the above optical waveguide. Here, in the case where the core width is different at the one end and the other end of the core as described above, or in the case where a pitch, which is a distance between adjacent cores, is different at the one end and the other end of the core, even if a plurality of cores are provided, such a configuration can be handled by creating a shape that is a combination of a linear region and a curved region.

However, it has been found that when one core is formed by combining a linear region and a curved region, the propagation loss of light is large.

Therefore, an object of the present invention is to provide an optical waveguide with reduced propagation loss of light, in which the optical waveguide has two or more cores, and at least one of the cores includes a linear region and a curved region.

As a result of further studies, the present inventors have found that the propagation loss of light mainly occurs at a joint between the linear region and the curved region of the core and at an inflection point of the curved region. The present inventors have also found that the above problem can be solved by creating an axis deviation at the joint or the inflection point in the core, and have completed the present invention.

That is, the present invention relates to the following [1] to [16].

[1] An optical waveguide including two or more cores and a cladding portion, in which
each of the cores is a continuous portion without branching from a start end to a terminal end in a propagation direction of light,
at least one of the cores includes a linear region and a curved region, and has an axis deviation at least at one of a joint between the linear region and the curved region and an inflection point of the curved region, and
the axis deviation occurs in a direction perpendicular to the propagation direction of light in a plan view.

[2] The optical waveguide according to [1], in which
the curved region includes a region having a minimum curvature of 15 mm or less.

[3] The optical waveguide according to [1] or [2], in which
the axis deviation has an absolute value of an axis deviation amount of 0.2 μm to 1 μm.

[4] The optical waveguide according to any one of [1] to [3], in which
each of the cores has an absolute value of a total amount of axis deviation amount of the axial deviation being 1 μm or less.

[5] The optical waveguide according to any one of [1] to [4], in which
at least two of the cores each include the linear region and the curved region and have an axis deviation at least at one of the joint between the linear region and the curved region and the inflection point of the curved region, and
the axis deviation occurs in the direction perpendicular to the propagation direction of light in the plan view.

[6] The optical waveguide according to any one of [1] to [5], in which
a pitch is defined as a distance between one core and an adjacent core,
the cores have the pitch different at the start end and the terminal end,
the difference in the pitch is formed by a pitch conversion region in the core,
the pitch conversion region includes the curved region, and
the pitch conversion region has a core width (Wp) of 2 μm to 8 μm.

[7] The optical waveguide according to [6], in which
the pitch conversion region has a ratio (Hp/Wp) of a core height (Hp) to the core width (Wp) of 1.0 or less.

[8] The optical waveguide according to any one of [1] to [7], in which
the core has portions having different core widths along the propagation direction of light.

[9] The optical waveguide according to any one of [1] to [8], in which
the core has different core widths at the start end and the terminal end.

[10] The optical waveguide according to any one of [1] to [9], in which
the core has a portion a where a core width is the smallest and the portion a has a core height (Ha) of 1.3 μm to 4.5 μm.

[11] The optical waveguide according to any one of [1] to [10], in which
the core has a portion a where a core width is the smallest and the portion a has a ratio (Ha/Wa) of a core height (Ha) to a core width (Wa) being 1.25 or less.

[12] The optical waveguide according to any one of [1] to [10], in which
the core further includes an exposed coupling portion, and the exposed coupling portion is a region of the core including at least one of the start end and the terminal end.

[13] The optical waveguide according to any one of [1] to [12], in which
the optical waveguide includes four or more of the cores,
a pitch is defined as a distance between one core and an adjacent core, and
in all the cores, a difference between a maximum value and a minimum value of the pitch is 2 μm or less at the start end.

[14] The optical waveguide according to any one of [1] to [13], in which
the optical waveguide includes four or more of the cores,
a pitch is defined as a distance between one core and an adjacent core, and
in all of the cores, a difference between a maximum value and a minimum value of the pitch is 2 μm or less at the terminal end.

[15] The optical waveguide according to any one of [1] to [14], in which
a pitch is defined as a distance between one core and an adjacent core, and
the pitch is 8 μm to 500 μm at least at one of the start end and the terminal end.

[16] An optical integrated device, including: the optical waveguide according to any one of [1] to [15] and a semi-conductor substrate connected to the optical waveguide, in which
light propagated in a single mode is introduced into the semi-conductor substrate via the core of the optical waveguide.

The optical waveguide according to the present invention can reduce propagation loss of light even in the case where the optical waveguide has a core including a linear region and a curved region.

### BRIEF DESCRIPTION OF DRAWINGS

FIG. 1 is a schematic plan view illustrating one aspect of an optical waveguide 10 according to the present embodiment.

FIG. 2 is a schematic plan view illustrating one aspect of the optical waveguide 10 according to the present embodiment.

FIG. 3 is an enlarged schematic plan view of two cores in the vicinity of a curved region C in the optical waveguide 10 according to the present embodiment.

FIG. 4 is an enlarged schematic plan view of two cores in the vicinity of the curved region C in the optical waveguide 10 according to the present embodiment.

FIG. 5 is an explanatory diagram of a model in which a core used for simulation analysis of optical loss in a pitch conversion region is viewed in a plan view.

FIG. 6 is a schematic cross-sectional view of the pitch conversion region including the core in the explanatory diagram of FIG. 5.

FIG. 7 is a schematic vertical cross-sectional view of the vicinity of a terminal end S of a core in a model used for simulation analysis regarding connection loss in an adiabatic connecting portion.

FIG. 8 is a schematic transverse cross-sectional view of the vicinity of the terminal end S of the core in the model used for simulation analysis regarding connection loss in the adiabatic connecting portion.

FIG. 9 is a schematic cross-sectional view illustrating an evaluation model of an optical waveguide 10c including a start end A of a core 11c used for simulation analysis of connection loss in a single-mode connecting portion.

### DESCRIPTION OF EMBODIMENTS

Hereinafter, the present invention will be described in detail, but the present invention is not limited to the following embodiment and can be freely modified and implemented without departing from the gist of the present invention. In addition, “to” indicating a numerical range is used to include numerical values written before and after it as a lower limit value and an upper limit value.

### <Optical Waveguide>

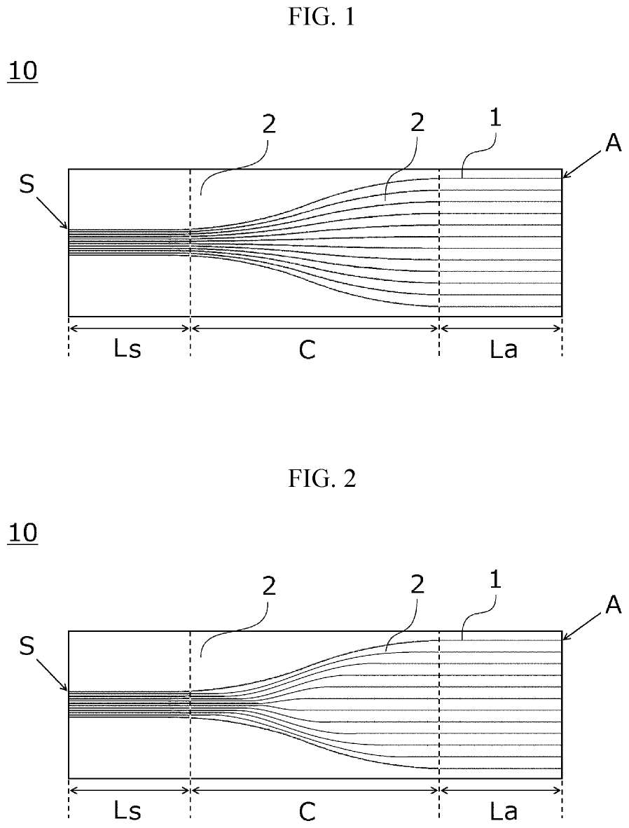

FIG. 1 is a schematic plan view illustrating one aspect of an optical waveguide 10 according to the present embodiment. The optical waveguide 10 according to the present embodiment includes two or more cores 1 and a cladding portion 2.

Light propagates by passing through the cores 1, and each of the cores 1 in the present embodiment is a continuous portion without branching from a start end A to a terminal end S through which light propagates.

At least one of the cores 1 includes a linear region L (a linear region La closer to the start end A and a linear region Ls closer to the terminal end S) and a curved region C. The combination of the linear region L and the curved region C is useful in the case where a pitch Pa′ of the cores 1 at the start end A and a pitch Ps of the cores 1 at the terminal end S are desired to be different when the pitch is defined as a distance between adjacent cores 1. In order to make the pitch Pa′ of the cores 1 at the start end A different from the pitch Ps at the terminal end S of the cores 1, a length and a curvature of the curved region C may be adjusted, and thus the curved region C may be referred to as a pitch conversion region.

The curvature of the curved region C of the core 1 differs depending on a positional relation with other cores 1 in the optical waveguide 10. For example, in FIG. 1, the curvature of the curved region C is smaller as the core 1 positioned on an outer side, and the curvature of the curved region C in the core 1 is larger and closer to a straight line as approaching the center.

The curvature of the curved region C of the core 1 is preferably small from the viewpoint of reducing the size of the optical waveguide 10. On the other hand, bending loss increases when the curvature is too small. In contrast, in the optical waveguide 10 according to the present embodiment, an increase in the bending loss can be prevented by providing an axis deviation, even in the case where the curvature (bending radius) is reduced.

The curved region C of the core 1 in the present embodiment preferably includes a region having a minimum curvature of 15 mm or less. In other words, the minimum curvature of the curved region C of the core 1 is preferably 15 mm or less. The minimum curvature is more preferably 12 mm or less, still more preferably 11 mm or less, and most preferably 10 mm or less. On the other hand, a lower limit of the minimum curvature is, for example, 2 mm or more.

The curvature (bending radius) of the core 1 in the present description means a curvature (bending radius) of a center of a core width of the core.

The number of the cores 1 including the linear region L and the curved region C as described above may be at least one, but is preferably two or more, more preferably four or more, and all the cores may include the linear region L, and the curved region C.

All the two or more cores 1 constituting the optical waveguide 10 do not need to satisfy the minimum curvature, and for example, the outermost core 1 in a plan view may satisfy the minimum curvature. The minimum curvature of the curved region C of the core positioned at the center may be 100 mm or more or 200 mm or more. There may also be a core that does not have the curved region C and includes only the linear region L, such as the core positioned at the center or the core around the center.

In FIG. 1, for all the cores 1, the linear region La closer to the start end A and the linear region Ls closer to the terminal end S have the same length, and the length in a region where the curved region C exists is also the same. However, the present embodiment is not limited to the above aspect.

For example, as illustrated in FIG. 2, the linear region L may be shorter and the region where the curved region C exists may be longer as the core 1 positioned on the outer side, and the linear region L in the core 1 may be longer and the region where the curved region C exists may be shorter as the core 1 closer to the center. In FIG. 2, the curvature of the curved region C may be the same in all the cores 1.

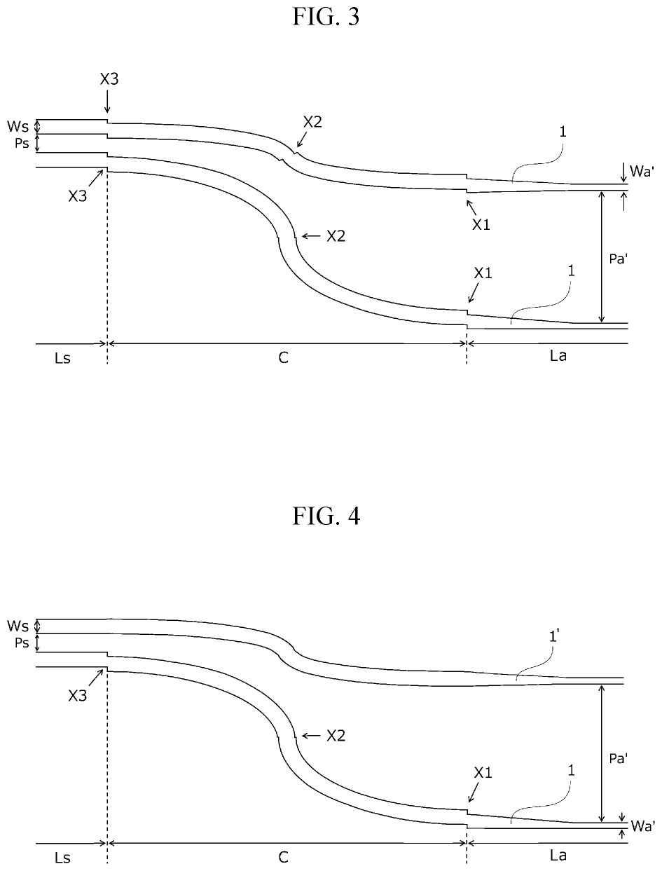

The core 1 including the linear region L and the curved region C in the present embodiment has an axis deviation at least at one of a joint between the linear region L and the curved region C and an inflection point of the curved region C. As illustrated in FIG. 3, the axis deviation occurs in a direction perpendicular to a propagation direction of light in a plan view. In the curved region C, the vertical direction means a normal direction perpendicular to a tangent of the curve.

In the case where there are two or more cores 1 including the linear region L and the curved region C, one or more of the two or more cores 1 may have the axis deviation as described above, and the other cores may have any aspect. That is, the other cores may be formed of only the linear region L or may have the linear region L and the curved region C. The other cores may or may not have the axis deviation.

Therefore, in the case where there are two or more cores 1 including the linear region L and the curved region C, there can be any number but one or more of cores having the axis deviation as described above, and for example, two or more cores may have the axis deviation, or all the cores may have the axis deviation.

As described above, at least one of the cores 1 including the linear region L and the curved region C in the present embodiment has an axis deviation at least at one of the joint between the linear region L and the curved region C and the inflection point of the curved region C.

FIG. 4 is an aspect thereof, and is an example in which one core denoted by reference numeral 1 includes the linear region L and the curved region C, and has axis deviations occurring in a direction perpendicular to a propagation direction of light in a plan view, and the other core denoted by reference numeral 1′ includes the linear region L and the curved region C but has no axis deviation.

FIG. 3 is an enlarged schematic plan view of the two cores 1 in the vicinity of the curved region C in the optical waveguide 10 according to the present embodiment.

Propagation loss of light mainly occurs at the joint between the linear region L and the curved region C and at the inflection point of the curved region C. On the other hand, it is possible to suitably reduce the propagation loss of light by creating an axis deviation at the joint between the linear region L and the curved region C and at the inflection point of the curved region C.

Specifically, as illustrated in FIG. 3, a joint X1 between the linear region La and the curved region C closer to start end A of the core 1 has an axis deviation. An inflection point X2 in the curved region C, that is, a point at which the curve changes from an upwardly convex state to a downwardly convex state also has an axis deviation. Further, a joint X3 between the curved region C and the linear region Ls closer to the terminal end S of the core 1 also has an axis deviation.

From the viewpoint of further reducing the propagation loss of light, each of the cores 1 in the present embodiment may have one or more axis deviations at one or more of the joint X1, the inflection point X2, and the joint X3, but it is preferable that each of the cores 1 has axis deviations at all the joints X1, the inflection points X2, and the joints X3.

The axis deviation of the core 1 in the present embodiment preferably has an absolute value of an axis deviation amount of 0.2 μm to 1 μm. Here, from the viewpoint of further reducing the propagation loss of light, the absolute value of the axis deviation amount is preferably 0.2 μm or more, more preferably 0.3 μm or more, and still more preferably 0.4 μm or more. In addition, from the viewpoint of reducing the pitch that is the distance of adjacent cores at the start end A and the terminal end S, the absolute value of the axis deviation amount is preferably 1 μm or less, more preferably 0.8 μm or less, and still more preferably 0.6 μm or less.

In the case where the core 1 has a plurality of axis deviations, it is preferable that one or more of the axis deviations satisfy the above-described range of the absolute value of the axis deviation amount, and it is more preferable that all the axis deviations satisfy the above-described range.

In the case where the optical waveguide according to the present embodiment includes two or more cores each having a linear region and a curved region and having an axis deviation, it is preferable that the two or more cores having an axis deviation satisfy the above-described range of the absolute value of the axis deviation amount, and it is more preferable that all the cores satisfy the above-described range of the absolute value of the axis deviation amount. Further, it is more preferable that all the axis deviations satisfy the above-described range.

In the cores 1 in the present embodiment, the absolute value of the total amount of the axis deviation amounts of the axis deviations is preferably 1 μm or less. Here, regarding the axis deviation, for example, in FIG. 3, when the axis deviation at the joint X1 is regarded as a negative axis deviation, the axis deviation at the inflection point X2 is a positive axis deviation, and the axis deviation at the joint X3 is a negative axis deviation. The absolute value of the total amount of the axis deviation amounts means the absolute value of the total amount of the axis deviation amounts at the joint X1, the inflection point X2, and the joint X3, taking into account positive and negative values.

From the viewpoint of aligning an interval of the pitch with an adjacent core at the start end A or the terminal end S, the absolute value of the total amount of the axis deviation amounts is preferably 1 μm or less, more preferably 0.7 μm or less, still more preferably 0.4 μm or less, most preferably 0.2 μm or less, and may be 0 μm.

The core 1 in the present embodiment may have portions having different core widths along the propagation direction of light. For example, the core width may be different at the start end A and the terminal end S through which light propagates. This is because, in silicon photonics, the performance required for the start end A is different from that for the terminal end S depending on the mode, such as the start end A being connected to an optical fiber, and the terminal end S being connected to a Si chip (silicon optical waveguide), and the suitable core width is also different.

The core width in the present description refers to a width of a core in a direction perpendicular to the thickness direction of the optical waveguide 10 in a cross section perpendicular to the propagation direction of light in the core 1.

In the case where the shape of the cross section of the core 1 is other than a rectangular shape, an average value of widths of cores in the direction perpendicular to the thickness direction of the optical waveguide 10 in the cross section is defined as the core width.

Examples of the shape other than the rectangular shape include a trapezoid, a circle, an ellipse, and a polygon, and the shape may be a rectangle, a trapezoid, a polygon, or the like, with rounded vertices.

In the case where the core width is different at the start end A and the terminal end S, the core width may be gradually changed from the start end A to the terminal end S over the whole, or the core width may be changed in a partial region from the start end A to the terminal end S.

In the case where the core width is changed in a partial region from the start end A to the terminal end S, it is more preferable to include a region in which the core width is changed in the linear region La closer to the start end A, from the viewpoint of stable light propagation in the curved region.

The core width Wa of the core 1 in the present embodiment at a portion a where the core width is the smallest is preferably 1.3 μm to 4.5 μm. The portion a is, for example, the core width at the start end A, and in this case, core width Wa′=core width Wa.

From the viewpoint of setting a ratio (Ha/Wa), which will be described later, in a suitable range, the core width Wa is preferably 1.3 μm or more, more preferably 1.5 μm or more, still more preferably 1.8 μm or more, and even more preferably 2.0 μm or more, and is also preferably 4.5 μm or less, more preferably 4.0 μm or less, still more preferably 3.5 μm or less, and even more preferably 3.0 μm or less.

The core height Ha at the portion a where the core width is the smallest is preferably 1.3 μm to 4.5 μm. From the viewpoint of reducing loss when connecting to a single-mode optical fiber, the core height Ha is preferably 1.3 μm or more, more preferably 1.4 μm or more, still more preferably 1.5 μm or more, even more preferably 1.6 μm or more, and particularly preferably 1.8 μm or more. From the viewpoint of preventing film peeling of the core, the core height Ha is preferably 4.5 μm or less, more preferably 3.0 μm or less, still more preferably 2.5 μm or less, and even more preferably 2.1 μm or less.

The core height in the present description refers to the height of the core 1 in the thickness direction of the optical waveguide 10 in a cross section perpendicular to the propagation direction of light in the core 1.

The ratio (Ha/Wa) of the core height (Ha) to the core width (Wa) at the portion a where the core width is the smallest is preferably 1.25 or less. From the viewpoint of preventing film peeling of the core, the ratio (Ha/Wa) is preferably 1.25 or less, more preferably 1.15 or less, still more preferably 1.05 or less, and even more preferably 0.95 or less. From the viewpoint of reducing polarization-dependent loss, the ratio (Ha/Wa) is preferably 0.4 or more, more preferably 0.6 or more, still more preferably 0.7 or more, and most preferably 0.8 or more.

The core width Ws at the terminal end S of the core 1 in the present embodiment is preferably 3 μm to 8 μm. Here, from the viewpoint of reducing loss when connecting to a silicon optical waveguide, the core width Ws is preferably 3 μm or more, more preferably 3.5 μm or more, and still more preferably 4 μm or more. From the same viewpoint, the core width Ws is preferably 8 μm or less, more preferably 7 μm or less, and still more preferably 6 μm or less.

In the core 1 according to the present embodiment, in the case where the pitch, which is the distance to the adjacent core, is different at the start end A and the terminal end S, the difference in the pitch is implemented by a pitch conversion region including the curved region C.

The core width (Wp) in the pitch conversion region of the core 1 is preferably 2 μm to 8 μm. Here, from the viewpoint of reducing bending loss in the curved region C, the core width (Wp) is preferably 2 μm or more, more preferably 2.5 μm or more, still more preferably 3 μm or more, even more preferably 3.5 μm or more, yet still more preferably 4 μm or more, and particularly preferably 4.5 μm or more. From the viewpoint of preventing disturbance of a mode of propagating light, the core width (Wp) is preferably 8 μm or less, more preferably 6 μm or less, still more preferably 5.5 μm or less, and particularly preferably 5 μm or less.

It is preferable that the core width (Wp) in the pitch conversion region is constant from the viewpoint of stable light propagation, but an aspect in which the core width (Wp) changes in the pitch conversion region is not excluded. In the case where the core width (Wp) changes in the pitch conversion region, it is preferable that the core width (Wp) in at least a part of the pitch conversion region is within the above-described range.

The core height (Hp) in the pitch conversion region of the core 1 is preferably 1.3 μm to 4.5 μm. From the viewpoint of reducing loss when connecting to a single-mode optical fiber, the core height Hp is preferably 1.3 μm or more, more preferably 1.4 μm or more, still more preferably 1.5 μm or more, even more preferably 1.6 μm or more, and particularly preferably 1.8 μm or more. From the viewpoint of preventing film peeling of the core, the core height Hp is preferably 4.5 μm or less, more preferably 3.0 μm or less, still more preferably 2.5 μm or less, and even more preferably 2.1 μm or less.

The core height of the core 1 is basically constant along the propagation direction of light. Therefore, the core height Hp and the core height Ha are preferably in the same range. The core height of a region having the largest core width, such as the terminal end S of the core 1, is preferably in the same range as described above.

The ratio (Hp/Wp) of the core height (Hp) to the core width (Wp) in the pitch conversion region of the core 1 is preferably 1.0 or less. Here, from the viewpoint of ease of formation of the core 1 having an axis deviation, the ratio (Hp/Wp) is preferably 0.9 or less, more preferably 0.8 or less, still more preferably 0.7 or less, and most preferably 0.6 or less. From the viewpoint of reducing the polarization-dependent loss, the ratio (Hp/Wp) is preferably 0.2 or more.

The optical waveguide 10 according to the present embodiment may include two or more parallel cores 1, but may include four or more, six or more, eight or more cores 1, or the like. An upper limit of the number of the parallel cores is not particularly limited, but is, for example, 1024 or less.

The number of the parallel cores 1 may be an odd number such as three or five.

In the case where the optical waveguide 10 according to the present embodiment has four or more cores 1, in all the cores 1, the difference between the maximum value and the minimum value of the pitch, which is the distance between the adjacent cores 1, may be 2 μm or less at the start end A through which light propagates. This makes it possible to equalize the interval of the pitch with an adjacent core at the start end A.

The difference is preferably 2 μm or less, more preferably 1.5 μm or less, still more preferably 1 μm or less, and may be 0 μm, that is, all the cores 1 may have equal intervals at the start end A.

In the case where the optical waveguide 10 according to the present embodiment has four or more cores 1, in all the cores 1, the difference between the maximum value and the minimum value of the pitch, which is the distance between the adjacent cores 1, may be 2 μm or less at the terminal end S through which light propagates. This makes it possible to equalize the interval of the pitch with an adjacent core at the terminal end S.

The difference is preferably 2 μm or less, more preferably 1.5 μm or less, still more preferably 1 μm or less, and may be 0 μm, that is, all the cores 1 may have equal intervals at the terminal end S.

In the optical waveguide 10 according to the present embodiment, the pitch, which is the distance between the adjacent cores 1, is preferably 8 μm to 500 μm at least at one of the start end A and the terminal end S through which light propagates. Here, from the viewpoint of preventing crosstalk, the pitch is preferably 8 μm or more, more preferably 15 μm or more, and still more preferably 25 μm or more. From the viewpoint of high-density optical wiring, the pitch is preferably 500 μm or less, more preferably 130 μm or less, still more preferably 80 μm or less, and most preferably 60 μm or less.

In silicon photonics, for example, in the case where single-mode light propagates from an optical fiber from the start end A of the core, the pitch at the start end A is preferably 50 μm to 500 μm. The pitch is preferably 50 μm or more, more preferably 80 μm or more, and still more preferably 125 μm or more, and is preferably 500 μm or less, more preferably 250 μm or less, and still more preferably 130 μm or less.

In silicon photonics, for example, in the case where the terminal end S of the core is a coupling portion coupled to a Si chip (silicon optical waveguide), the pitch at the terminal end S is preferably 8 μm to 100 μm. Here, the pitch is preferably 8 μm or more, more preferably 12 μm or more, still more preferably 20 μm or more, and even more preferably 30 μm or more. The pitch at the terminal end S is preferably 100 μm or less, more preferably 80 μm or less, still more preferably 60 μm or less, and most preferably 40 μm or less.

In the optical waveguide 10 according to the present embodiment, a region including at least one of the start end A and the terminal end S of the core 1 may be an exposed coupling portion. The exposed core 1 means that the core 1 is positioned at the outermost surface of the optical waveguide 10, and the cladding portion 2 in this region has only under-cladding and no over-cladding.

In silicon photonics, the coupling portion in which a part of the core 1 is exposed is used, for example, as an adiabatic coupling portion with a silicon optical waveguide.

The length of the coupling portion in the propagation direction of light of the optical waveguide 10 is preferably 100 μm to 10000 μm. Here, from the viewpoint of ensuring a sufficient length for use as a connecting portion with a silicon optical waveguide, the length is preferably 100 μm or more, more preferably 300 μm or more, still more preferably 500 μm or more, and particularly preferably 1000 μm or more. On the other hand, from the viewpoint of reducing connection loss due to adhesive absorption in the case of connecting to a silicon optical waveguide by using an adhesive such as epoxy resin, the length is preferably 10000 μm or less, more preferably 5000 μm or less, and still more preferably 3000 μm or less. The core 1 in the present embodiment may have a refractive index distribution therein. In this case, the refractive index distribution may be such that the refractive index decreases toward a distant side with respect to the center of the core. The refractive index distribution may have a refractive index distribution in which the refractive index on the over-cladding portion side is high and the refractive index on the under-cladding portion side is low, or may have a refractive index distribution in which the refractive index on the over-cladding portion side is low and the refractive index on the under-cladding portion side is high.

The refractive index in the present description is a value measured at room temperature.

The core 1 means a region through which light passes. In the case where the core 1 has a refractive index distribution, when a refractive index difference represented by (Nmax-N) is represented by Δn using a maximum value Nmax of the refractive index of the core and a refractive index N of the cladding portion, a region in which the refractive index is a value represented by {N+ (Δn/2)} or more is defined as the core.

The cladding portion 2 in the present embodiment may have a lower refractive index than the core 1. The cladding portion 2 may have a single refractive index, or may have portions having different refractive indices on a close side and a distant side with respect to the core 1. In this case, the refractive index may decrease toward the distant side with respect to the core 1, or may increase toward the distant side with respect to the core 1.

In the optical waveguide 10 according to the present embodiment, the relative refractive index difference between the core 1 and the cladding portion 2 is preferably from 0.006 to 0.017 from the viewpoint of reducing loss during connection to a single-mode optical fiber and from the viewpoint of reducing bending loss in the curved region C. The relative refractive index difference is more preferably 0.007 or more, and still more preferably 0.008 or more, and is more preferably 0.015 or less, still more preferably 0.012 or less, and even more preferably 0.011 or less.

The relative refractive index difference can be obtained by the following equation.

Relative refractive index difference=(refractive index of core−refractive index of cladding portion)/refractive index of cladding portion

As described above, in the case where the core 1 has a refractive index distribution therein, or in the case where the cladding portion 2 has a portion with different refractive index on the close side and the distant side with respect to the core 1, the relative refractive index difference between the core 1 and the cladding portion 2 is obtained by using an average value of the refractive index of the core 1, and the refractive index of the cladding portion 2 near the core 1.

The optical waveguide 10 according to the present embodiment can be mounted on, for example, an optical integrated device. In an aspect of the optical integrated device, the optical waveguide 10 is connected to a semi-conductor substrate, and light propagated in a single mode is introduced into the semi-conductor substrate through the core 1 of the optical waveguide 10. The semi-conductor substrate is preferably, for example, a silicon semi-conductor substrate.

The optical waveguide 10 according to the present embodiment is not limited to the above-described aspect, and may be mounted on a pluggable device.

### <Manufacturing Method>

A manufacturing method of the optical waveguide 10 according to the present embodiment is not particularly limited, and various methods can be adopted. Specific examples of the manufacturing method include a replication (stamper) method, a direct exposure method, a method that combines reactive ion etching (RIE) and a photolithography process, a method based on injection molding, a photobleaching method, a direct drawing method, a self-forming method, an ion exchange method, a laser irradiation method, and a sputtering method.

An aspect of a manufacturing method of the optical waveguide 10 according to the present embodiment will be described.

First, a coating liquid containing a curable composition (A), which is a constituent material of the cladding portion 2, is applied onto a substrate by a spin coating method. Subsequently, the curable composition (A) is cured to form the cladding portion 2.

Next, a coating liquid containing a constituent material of the core 1, such as a curable composition (B), is applied onto the cladding portion 2 by a spin coating method. Subsequently, the curable composition (B) is patterned by a photolithography process to form the core 1 on the cladding portion 2. At this time, the core 1 may be formed such that a portion of the core 1 having an axis deviation is formed by exposing the portion by using a photomask so as to have a desired shape with the axis deviation, and then performing development. After the core 1 is formed, post-baking may be performed as necessary.

In the case where it is desired to further form a cladding portion 2 as an over-cladding on the core 1, a coating liquid containing a curable composition (C), which is a constituent material of the over-cladding, is coated on the core 1. The curable composition (C) may be the same material as the curable composition (A), or may be a different material. Subsequently, the curable composition (C) is cured to form the cladding portion 2 as an over-cladding. At this time, by the photolithography process, it is possible to form a coupling portion in which the core 1 and the cladding portion 2 serving as under-cladding around the core 1 are exposed without the over-cladding portion.

### EXAMPLES

Hereinafter, the present invention will be described based on specific Examples. The present invention is not limited to the following Examples.

Although tests were conducted in Examples 1 to 52, all of the tests are test examples based on simulations of light propagation. Here, for all Examples, the case where there is an axis deviation at least at one of the joint between the linear region and the curved region and the inflection point of the curved region and the case where there is no axis deviation were examined. Therefore, in evaluations of Examples 1 to 52, both of the results of examples having an axis deviation and the results of comparative examples having no axis deviation are shown.

### Examples 1 to 52

In Examples 1 to 52, simulations of light propagation in a TE mode and a TM mode were performed by a finite difference beam propagation method using an optical fiber/waveguide design/analysis software BeamPROP (manufactured by Synopsys) according to a bi-directional BPM method which is a simulation engine.

### <Evaluation Method>

### <Optical Loss in Pitch Conversion Region: Depending on Presence or Absence of Axis Deviation>

The simulation analysis of loss in the pitch conversion region in the optical waveguide was performed.

As the evaluation model, in order to simulate the pitch conversion region of the optical waveguide in a pseudo manner, as illustrated in the explanatory diagram of FIG. 4 in which the core is seen in a plan view, used was a core 1 in which a curved region C of an S-shaped structure was formed by connecting a portion curved with a constant curvature radius (bending radius R) in a horizontal direction and a portion curved with the same absolute value of the curvature as described above but a negative curvature. In the core 1, the joint between the linear region La and the curved region C was defined as X1, the inflection point at which the curvature in the curved region C changes from positive to negative at a bending radius of R (mm) was defined as X2, the joint between the curved region C and the linear region Is was defined as X3, and axis deviation amounts at the joint X1, the inflection point X2, and the joint X3 were respectively set.

Here, the curved region C is a region referred to as a pitch conversion region, and a displacement amount between centers of core widths in directions parallel to the core widths of the cores 1 at the start end A and the terminal end S caused by the presence of the pitch conversion region is defined as a pitch conversion distance α (μm).

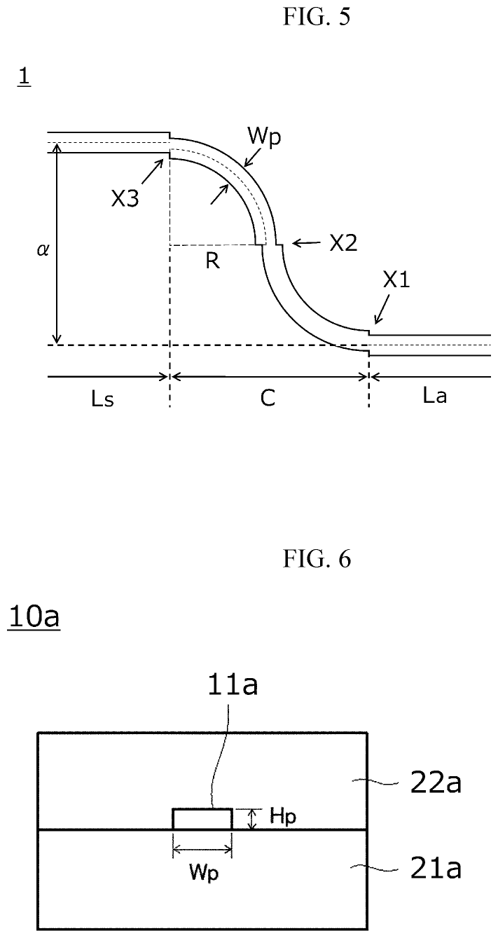

FIG. 6 is a schematic cross-sectional view of the pitch conversion region including the core illustrated in the explanatory diagram of FIG. 5. As illustrated in FIG. 6, the optical waveguide 10a has, as a pseudo pitch conversion region that simulates the pitch conversion region of the core, a core curved portion in which a core 11 curved with a constant bending radius R (mm) in the horizontal direction is covered with an under-cladding portion 21a and an over-cladding portion 22a of the cladding portion.

The core width in the pitch conversion region is Wp (μm), the core height is Hp (μm), and both the core width Wp and the core height Hp were set constant without deviation.

The structure of the evaluation model of each of Examples is as follows.
Core 11a: pitch conversion region (curved region C)
Core width Wp: as listed in the table below
Core height Hp: as listed in the table below
Refractive index: as listed in the table below
Pitch conversion distance α: as listed in the table below
Bending radius R: as listed in the table below
Cladding portion: under-cladding portion 21a
Cladding width: 60 μm
Cladding height: 30 μm
Refractive index: as listed in the table below
Cladding portion: over-cladding portion 22a
Cladding width: 60 μm
Cladding height: 30 μm
Refractive index (same as the refractive index of under-cladding)

### Axis Deviation Amount

Joint X1: as listed in the table below
Inflection point X2: as listed in the table below
Joint X3: as listed in the table below

The results of the optical loss in the case of having an axis deviation and the case of having no axis deviation by the simulation analysis are shown in the tables below.

TABLE 1

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Core width Wp (μm) | 5.000 | 5.000 | 5.000 | 5.000 | 5.000 | 5.000 | 5.000 | 5.000 | 5.000 |
| Core height Hp (μm) | 2.000 | 2.000 | 2.000 | 2.000 | 2.000 | 2.000 | 2.000 | 2.100 | 2.100 |
| Hp/Wp | 0.400 | 0.400 | 0.400 | 0.400 | 0.400 | 0.400 | 0.400 | 0.420 | 0.420 |
| Refractive index (core) | 1.533 | 1.533 | 1.533 | 1.533 | 1.533 | 1.533 | 1.533 | 1.530 | 1.530 |
| Refractive index (cladding) | 1.520 | 1.520 | 1.520 | 1.520 | 1.520 | 1.520 | 1.520 | 1.516 | 1.518 |
| Relative refractive index | 0.0086 | 0.0086 | 0.0086 | 0.0086 | 0.0086 | 0.0086 | 0.0086 | 0.0092 | 0.0079 |
| difference between core and | | | | | | | | | |
| cladding | | | | | | | | | |
| Pitch conversion distance A | 1100 | 1100 | 1100 | 1100 | 1100 | 1100 | 1100 | 700 | 700 |
| (μm) | | | | | | | | | |
| Wavelength (μm) | 1.31 | 1.31 | 1.31 | 1.31 | 1.31 | 1.31 | 1.36 | 1.31 | 1.31 |
| Bending radius R (mm) | 8.0 | 8.0 | 8.0 | 8.0 | 8.0 | 8.0 | 8.0 | 9.0 | 9.0 |
| Axis deviation amount: joint | −0.2 | −0.2 | 0 | 0 | 0 | 0 | −0.2 | −0.2 | −0.2 |
| X1 (μm) | | | | | | | | | |
| Axis deviation amount: | 0.4 | 0 | 0.2 | 0.4 | 0.5 | 0.6 | 0.4 | 0.4 | 0.4 |
| inflection point X2 (μm) | | | | | | | | | |
| Axis deviation amount: joint | −0.2 | −0.2 | 0 | 0 | 0 | 0 | −0.2 | −0.2 | −0.2 |
| X3 (μm) | | | | | | | | | |
| \|Total amount of axis | 0 | −0.4 | 0.2 | 0.4 | 0.5 | 0.6 | 0 | 0 | 0 |
| deviation amounts\| (X1 + X2 + | | | | | | | | | |
| X3) (μm) | | | | | | | | | |
| Optical loss (no axis | 0.15 | 0.15 | 0.15 | 0.15 | 0.15 | 0.15 | 0.20 | 0.07 | 0.14 |
| deviation, TE mode) (dB/cm) | | | | | | | | | |
| Optical loss (no axis | 0.15 | 0.15 | 0.15 | 0.15 | 0.15 | 0.15 | 0.20 | 0.07 | 0.15 |
| deviation, TM mode) (dB/cm) | | | | | | | | | |
| Optical loss (with axis | 0.04 | 0.11 | 0.09 | 0.07 | 0.08 | 0.09 | 0.07 | 0.02 | 0.04 |
| deviation, TE mode) (dB/cm) | | | | | | | | | |
| Optical loss (with axis | 0.04 | 0.12 | 0.10 | 0.08 | 0.08 | 0.09 | 0.08 | 0.02 | 0.04 |
| deviation, TM mode) (dB/cm) | | | | | | | | | |
| Optical loss reduction amount | 0.11 | 0.04 | 0.05 | 0.07 | 0.07 | 0.06 | 0.12 | 0.05 | 0.10 |
| (TE mode) (dB/cm) | | | | | | | | | |
| Optical loss reduction amount | 0.11 | 0.04 | 0.05 | 0.07 | 0.07 | 0.06 | 0.12 | 0.06 | 0.10 |
| (TM mode) (dB/cm) | | | | | | | | | |

TABLE 2

| | Ex. 10 | Ex. 11 | Ex. 12 | Ex. 13 | Ex. 14 | Ex. 15 | Ex. 16 | Ex. 17 | Ex. 18 |
|---|---|---|---|---|---|---|---|---|---|
| Core width Wp (μm) | 5.000 | 4.500 | 4.500 | 4.500 | 5.500 | 5.500 | 5.500 | 4.000 | 4.000 |
| Core height Hp (μm) | 2.100 | 2.100 | 2.100 | 2.100 | 2.500 | 2.500 | 2.500 | 2.000 | 2.000 |
| Hp/Wp | 0.420 | 0.467 | 0.467 | 0.467 | 0.455 | 0.455 | 0.455 | 0.500 | 0.500 |
| Refractive index (core) | 1.530 | 1.530 | 1.530 | 1.530 | 1.528 | 1.528 | 1.528 | 1.530 | 1.530 |
| Refractive index (cladding) | 1.520 | 1.517 | 1.517 | 1.517 | 1.514 | 1.515 | 1.516 | 1.517 | 1.517 |
| Relative refractive index | 0.0066 | 0.0086 | 0.0086 | 0.0086 | 0.0092 | 0.0086 | 0.0079 | 0.0086 | 0.0086 |
| difference between core and | | | | | | | | | |
| cladding | | | | | | | | | |
| Pitch conversion distance A | 700 | 700 | 1500 | 3100 | 1500 | 1500 | 1500 | 700 | 700 |
| (μm) | | | | | | | | | |
| Wavelength (μm) | 1.31 | 1.31 | 1.31 | 1.31 | 1.55 | 1.55 | 1.55 | 1.31 | 1.31 |
| Bending radius R (mm) | 9.0 | 8.0 | 8.0 | 8.0 | 9.0 | 9.0 | 9.0 | 6.0 | 9.0 |
| Axis deviation amount: joint | −0.3 | −0.2 | −0.2 | −0.2 | −0.2 | −0.2 | −0.3 | −0.3 | −0.2 |
| X1 (μm) | | | | | | | | | |
| Axis deviation amount: | 0.6 | 0.4 | 0.4 | 0.4 | 0.4 | 0.4 | 0.6 | 0.6 | 0.4 |
| inflection point X2 (μm) | | | | | | | | | |
| Axis deviation amount: joint | −0.3 | −0.2 | −0.2 | −0.2 | −0.2 | −0.2 | −0.3 | −0.3 | −0.2 |
| X3 (μm) | | | | | | | | | |
| \|Total amount of axis | 0 | 0 | 0 | 0 | 0 | 0 | 0 | 0 | 0 |
| deviation amounts\| (X1 + X2 + | | | | | | | | | |
| X3) (μm) | | | | | | | | | |
| Optical loss (no axis | 0.75 | 0.12 | 0.13 | 0.13 | 0.09 | 0.11 | 0.20 | 0.64 | 0.15 |
| deviation, TE mode) (dB/cm) | | | | | | | | | |
| Optical loss (no axis | 0.79 | 0.13 | 0.13 | 0.14 | 0.09 | 0.13 | 0.26 | 0.68 | 0.15 |
| deviation, TM mode) (dB/cm) | | | | | | | | | |
| Optical loss (with axis | 0.53 | 0.04 | 0.04 | 0.05 | 0.02 | 0.04 | 0.12 | 0.46 | 0.07 |
| deviation, TE mode) (dB/cm) | | | | | | | | | |
| Optical loss (with axis | 0.57 | 0.04 | 0.05 | 0.05 | 0.02 | 0.04 | 0.15 | 0.50 | 0.08 |
| deviation, TM mode) (dB/cm) | | | | | | | | | |
| Optical loss reduction amount | 0.22 | 0.08 | 0.09 | 0.09 | 0.07 | 0.06 | 0.08 | 0.17 | 0.07 |
| (TE mode) (dB/cm) | | | | | | | | | |
| Optical loss reduction amount | 0.22 | 0.08 | 0.09 | 0.09 | 0.07 | 0.09 | 0.11 | 0.18 | 0.07 |
| (TM mode) (dB/cm) | | | | | | | | | |

TABLE 3

| | Ex. 19 | Ex. 20 | Ex. 21 | Ex. 22 | Ex. 23 | Ex. 24 | Ex. 25 | Ex. 26 | Ex. 27 |
|---|---|---|---|---|---|---|---|---|---|
| Core width Wp (μm) | 4.000 | 4.000 | 5.000 | 5.000 | 5.000 | 5.000 | 6.000 | 6.000 | 6.000 |
| Core height Hp (μm) | 2.000 | 2.000 | 2.000 | 2.000 | 2.000 | 2.000 | 2.000 | 2.000 | 2.000 |
| Hp/Wp | 0.500 | 0.500 | 0.400 | 0.400 | 0.400 | 0.400 | 0.333 | 0.333 | 0.333 |
| Refractive index (core) | 1.530 | 1.530 | 1.530 | 1.530 | 1.530 | 1.530 | 1.530 | 1.530 | 1.530 |
| Refractive index (cladding) | 1.517 | 1.517 | 1.517 | 1.517 | 1.517 | 1.517 | 1.517 | 1.517 | 1.517 |
| Relative refractive index | 0.0086 | 0.0086 | 0.0086 | 0.0086 | 0.0086 | 0.0086 | 0.0086 | 0.0086 | 0.0086 |
| difference between core and | | | | | | | | | |
| cladding | | | | | | | | | |
| Pitch conversion distance A | 700 | 700 | 700 | 700 | 700 | 700 | 700 | 700 | 700 |
| (μm) | | | | | | | | | |
| Wavelength (μm) | 1.31 | 1.31 | 1.31 | 1.31 | 1.31 | 1.31 | 1.31 | 1.31 | 1.31 |
| Bending radius R (mm) | 12.0 | 15.0 | 6.0 | 9.0 | 12.0 | 15.0 | 6.0 | 9.0 | 12.0 |
| Axis deviation amount: joint | −0.1 | −0.1 | −0.3 | −0.2 | −0.1 | −0.1 | −0.4 | −0.2 | −0.2 |
| X1 (μm) | | | | | | | | | |
| Axis deviation amount: | 0.2 | 0.2 | 0.6 | 0.4 | 0.2 | 0.2 | 0.8 | 0.4 | 0.4 |
| inflection point X2 (μm) | | | | | | | | | |
| Axis deviation amount: joint | −0.1 | −0.1 | −0.3 | −0.2 | −0.1 | −0.1 | −0.4 | −0.2 | −0.2 |
| X3 (μm) | | | | | | | | | |
| \|Total amount of axis | 0 | 0 | 0 | 0 | 0 | 0 | 0 | 0 | 0 |
| deviation amounts\| (X1 + X2 + | | | | | | | | | |
| X3) (μm) | | | | | | | | | |
| Optical loss (no axis | 0.07 | 0.04 | 0.32 | 0.11 | 0.06 | 0.04 | 0.31 | 0.13 | 0.07 |
| deviation, TE mode) (dB/cm) | | | | | | | | | |
| Optical loss (no axis | 0.07 | 0.04 | 0.33 | 0.11 | 0.06 | 0.04 | 0.32 | 0.13 | 0.07 |
| deviation, TM mode) (dB/cm) | | | | | | | | | |
| Optical loss (with axis | 0.03 | 0.02 | 0.12 | 0.03 | 0.02 | 0.01 | 0.06 | 0.02 | 0.01 |
| deviation, TE mode) (dB/cm) | | | | | | | | | |
| Optical loss (with axis | 0.03 | 0.02 | 0.13 | 0.03 | 0.02 | 0.01 | 0.06 | 0.02 | 0.01 |
| deviation, TM mode) (dB/cm) | | | | | | | | | |
| Optical loss reduction amount | 0.04 | 0.02 | 0.20 | 0.08 | 0.04 | 0.03 | 0.25 | 0.11 | 0.06 |
| (TE mode) (dB/cm) | | | | | | | | | |
| Optical loss reduction amount | 0.04 | 0.03 | 0.20 | 0.08 | 0.04 | 0.03 | 0.26 | 0.11 | 0.06 |
| (TM mode) (dB/cm) | | | | | | | | | |

TABLE 4

| | Ex. 28 | Ex. 29 | Ex. 30 | Ex. 31 | Ex. 32 | Ex. 33 | Ex. 34 | Ex. 35 | Ex. 36 |
|---|---|---|---|---|---|---|---|---|---|
| Core width Wp (μm) | 6.000 | 4.000 | 4.000 | 4.000 | 4.000 | 5.000 | 5.000 | 5.000 | 5.000 |
| Core height Hp (μm) | 2.000 | 2.200 | 2.200 | 2.200 | 2.200 | 2.200 | 2.200 | 2.200 | 2.200 |
| Hp/Wp | 0.333 | 0.550 | 0.550 | 0.550 | 0.550 | 0.440 | 0.440 | 0.440 | 0.440 |
| Refractive index (core) | 1.530 | 1.530 | 1.530 | 1.530 | 1.530 | 1.530 | 1.530 | 1.530 | 1.530 |
| Refractive index (cladding) | 1.517 | 1.517 | 1.517 | 1.517 | 1.517 | 1.517 | 1.517 | 1.517 | 1.517 |
| Relative refractive index | 0.0086 | 0.0086 | 0.0086 | 0.0086 | 0.0086 | 0.0086 | 0.0086 | 0.0086 | 0.0086 |
| difference between core and | | | | | | | | | |
| cladding | | | | | | | | | |
| Pitch conversion distance A | 700 | 700 | 700 | 700 | 700 | 700 | 700 | 700 | 700 |
| (μm) | | | | | | | | | |
| Wavelength (μm) | 1.31 | 1.31 | 1.31 | 1.31 | 1.31 | 1.31 | 1.31 | 1.31 | 1.31 |
| Bending radius R (mm) | 15.0 | 6.0 | 9.0 | 12.0 | 15.0 | 6.0 | 9.0 | 12.0 | 15.0 |
| Axis deviation amount: joint | −0.2 | −0.2 | −0.1 | −0.1 | −0.1 | −0.3 | −0.2 | −0.1 | −0.1 |
| X1 (μm) | | | | | | | | | |
| Axis deviation amount: | 0.4 | 0.4 | 0.2 | 0.2 | 0.2 | 0.6 | 0.4 | 0.2 | 0.2 |
| inflection point X2 (μm) | | | | | | | | | |
| Axis deviation amount: joint | −0.2 | −0.2 | −0.1 | −0.1 | −0.1 | −0.3 | −0.2 | −0.1 | −0.1 |
| X3 (μm) | | | | | | | | | |
| \|Total amount of axis | 0 | 0 | 0 | 0 | 0 | 0 | 0 | 0 | 0 |
| deviation amounts\| (X1 + X2 + | | | | | | | | | |
| X3) (μm) | | | | | | | | | |
| Optical loss (no axis | 0.05 | 0.30 | 0.09 | 0.05 | 0.03 | 0.21 | 0.08 | 0.05 | 0.03 |
| deviation, TE mode) (dB/cm) | | | | | | | | | |
| Optical loss (no axis | 0.05 | 0.31 | 0.09 | 0.05 | 0.03 | 0.22 | 0.09 | 0.05 | 0.03 |
| deviation, TM mode) (dB/cm) | | | | | | | | | |
| Optical loss (with axis | 0.01 | 0.16 | 0.04 | 0.02 | 0.01 | 0.06 | 0.02 | 0.01 | 0.01 |
| deviation, TE mode) (dB/cm) | | | | | | | | | |
| Optical loss (with axis | 0.01 | 0.17 | 0.04 | 0.02 | 0.01 | 0.06 | 0.02 | 0.01 | 0.01 |
| deviation, TM mode) (dB/cm) | | | | | | | | | |
| Optical loss reduction amount | 0.04 | 0.13 | 0.05 | 0.03 | 0.02 | 0.16 | 0.06 | 0.04 | 0.03 |
| (TE mode) (dB/cm) | | | | | | | | | |
| Optical loss reduction amount | 0.04 | 0.13 | 0.05 | 0.03 | 0.02 | 0.16 | 0.07 | 0.04 | 0.03 |
| (TM mode) (dB/cm) | | | | | | | | | |

TABLE 5

| | Ex. 37 | Ex. 38 | Ex. 39 | Ex. 40 | Ex. 41 | Ex. 42 | Ex. 43 | Ex. 44 | Ex. 45 |
|---|---|---|---|---|---|---|---|---|---|
| Core width Wp (μm) | 6.000 | 6.000 | 6.000 | 6.000 | 4.000 | 4.000 | 4.000 | 4.000 | 5.000 |
| Core height Hp (μm) | 2.200 | 2.200 | 2.200 | 2.200 | 2.400 | 2.400 | 2.400 | 2.400 | 2.400 |
| Hp/Wp | 0.367 | 0.367 | 0.367 | 0.367 | 0.600 | 0.600 | 0.600 | 0.600 | 0.480 |
| Refractive index (core) | 1.530 | 1.530 | 1.530 | 1.530 | 1.530 | 1.530 | 1.530 | 1.530 | 1.530 |
| Refractive index (cladding) | 1.517 | 1.517 | 1.517 | 1.517 | 1.517 | 1.517 | 1.517 | 1.517 | 1.517 |
| Relative refractive index | 0.0086 | 0.0086 | 0.0086 | 0.0086 | 0.0086 | 0.0086 | 0.0086 | 0.0086 | 0.0086 |
| difference between core and | | | | | | | | | |
| cladding | | | | | | | | | |
| Pitch conversion distance A | 700 | 700 | 700 | 700 | 700 | 700 | 700 | 700 | 700 |
| (μm) | | | | | | | | | |
| Wavelength (μm) | 1.31 | 1.31 | 1.31 | 1.31 | 1.31 | 1.31 | 1.31 | 1.31 | 1.31 |
| Bending radius R (mm) | 6.0 | 9.0 | 12.0 | 15.0 | 6.0 | 9.0 | 12.0 | 15.0 | 6.0 |
| Axis deviation amount: joint | −0.3 | −0.2 | −0.2 | −0.1 | −0.2 | −0.1 | −0.1 | −0.1 | −0.2 |
| X1 (μm) | | | | | | | | | |
| Axis deviation amount: | 0.6 | 0.4 | 0.4 | 0.2 | 0.4 | 0.2 | 0.2 | 0.2 | 0.4 |
| inflection point X2 (μm) | | | | | | | | | |
| Axis deviation amount: joint | −0.3 | −0.2 | −0.2 | −0.1 | −0.2 | −0.1 | −0.1 | −0.1 | −0.2 |
| X3 (μm) | | | | | | | | | |
| \|Total amount of axis | 0 | 0 | 0 | 0 | 0 | 0 | 0 | 0 | 0 |
| deviation amounts\| (X1 + X2 + | | | | | | | | | |
| X3) (μm) | | | | | | | | | |
| Optical loss (no axis | 0.24 | 0.10 | 0.06 | 0.04 | 0.18 | 0.06 | 0.04 | 0.02 | 0.17 |
| deviation, TE mode) (dB/cm) | | | | | | | | | |
| Optical loss (no axis | 0.24 | 0.11 | 0.06 | 0.04 | 0.18 | 0.07 | 0.04 | 0.02 | 0.17 |
| deviation, TM mode) (dB/cm) | | | | | | | | | |
| Optical loss (with axis | 0.03 | 0.01 | 0.01 | 0.01 | 0.07 | 0.02 | 0.01 | 0.01 | 0.03 |
| deviation, TE mode) (dB/cm) | | | | | | | | | |
| Optical loss (with axis | 0.03 | 0.01 | 0.01 | 0.01 | 0.08 | 0.02 | 0.01 | 0.01 | 0.03 |
| deviation, TM mode) (dB/cm) | | | | | | | | | |
| Optical loss reduction amount | 0.20 | 0.09 | 0.05 | 0.03 | 0.10 | 0.04 | 0.03 | 0.01 | 0.14 |
| (TE mode) (dB/cm) | | | | | | | | | |
| Optical loss reduction amount | 0.21 | 0.09 | 0.05 | 0.03 | 0.11 | 0.04 | 0.03 | 0.02 | 0.14 |
| (TM mode) (dB/cm) | | | | | | | | | |

TABLE 6

| | Ex. 46 | Ex. 47 | Ex. 48 | Ex. 49 | Ex. 50 | Ex. 51 | Ex. 52 |
|---|---|---|---|---|---|---|---|
| Core width Wp (μm) | 5.000 | 5.000 | 5.000 | 6.000 | 6.000 | 6.000 | 6.000 |
| Core height Hp (μm) | 2.400 | 2.400 | 2.400 | 2.400 | 2.400 | 2.400 | 2.400 |
| Hp/Wp | 0.480 | 0.480 | 0.480 | 0.400 | 0.400 | 0.400 | 0.400 |
| Refractive index (core) | 1.530 | 1.530 | 1.530 | 1.530 | 1.530 | 1.530 | 1.530 |
| Refractive index (cladding) | 1.517 | 1.517 | 1.517 | 1.517 | 1.517 | 1.517 | 1.517 |
| Relative refractive index difference between | 0.0086 | 0.0086 | 0.0086 | 0.0086 | 0.0086 | 0.0086 | 0.0086 |
| core and cladding | | | | | | | |
| Pitch conversion distance A (μm) | 700 | 700 | 700 | 700 | 700 | 700 | 700 |
| Wavelength (μm) | 1.31 | 1.31 | 1.31 | 1.31 | 1.31 | 1.31 | 1.31 |
| Bending radius R (mm) | 9.0 | 12.0 | 15.0 | 6.0 | 9.0 | 12.0 | 15.0 |
| Axis deviation amount: joint X1 (μm) | −0.2 | −0.1 | −0.1 | −0.3 | −0.2 | −0.1 | −0.1 |
| Axis deviation amount: inflection point X2 | 0.4 | 0.2 | 0.2 | 0.6 | 0.4 | 0.2 | 0.2 |
| (μm) | | | | | | | |
| Axis deviation amount: joint X3 (μm) | −0.2 | −0.1 | −0.1 | −0.3 | −0.2 | −0.1 | −0.1 |
| \|Total amount of axis deviation amounts\| (X1 + | 0 | 0 | 0 | 0 | 0 | 0 | 0 |
| X2 + X3) (μm) | | | | | | | |
| Optical loss (no axis deviation, TE mode) | 0.07 | 0.04 | 0.03 | 0.17 | 0.13 | 0.04 | 0.04 |
| (dB/cm) | | | | | | | |
| Optical loss (no axis deviation, TM mode) | 0.07 | 0.04 | 0.03 | 0.20 | 0.09 | 0.05 | 0.03 |
| (dB/cm) | | | | | | | |
| Optical loss (with axis deviation, TE mode) | 0.02 | 0.01 | 0.00 | 0.02 | 0.01 | 0.01 | 0.00 |
| (dB/cm) | | | | | | | |
| Optical loss (with axis deviation, TM mode) | 0.02 | 0.01 | 0.00 | 0.02 | 0.01 | 0.01 | 0.00 |
| (dB/cm) | | | | | | | |
| Optical loss reduction amount (TE mode) | 0.05 | 0.03 | 0.02 | 0.15 | 0.12 | 0.03 | 0.04 |
| (dB/cm) | | | | | | | |
| Optical loss reduction amount (TM mode) | 0.06 | 0.03 | 0.02 | 0.18 | 0.08 | 0.04 | 0.03 |
| (dB/cm) | | | | | | | |

<Optical Loss from Adiabatic Connecting Portion to Single-Mode Connecting Portion>

Used was an optical waveguide 10 having the core 1 that has the start end A as a single-mode connecting portion with an optical fiber of single-mode light, contains the linear region La, the curved region C which is a pitch conversion region, and the linear region Ls provided therefrom, and has the terminal end S as an adiabatic connecting portion with a silicon optical waveguide. By using this optical waveguide 10, connection loss at the single-mode connecting portion, optical loss in the pitch conversion region in the optical waveguide, and connection loss at the adiabatic connecting portion were obtained by simulations.

The pitch conversion region has the same configuration as that of Example 9.

### (1. Connection Loss of Adiabatic Connecting Portion)

The simulation analysis of the connection loss at the adiabatic connecting portion between the optical waveguide and the silicon optical waveguide was performed by the following evaluation model.

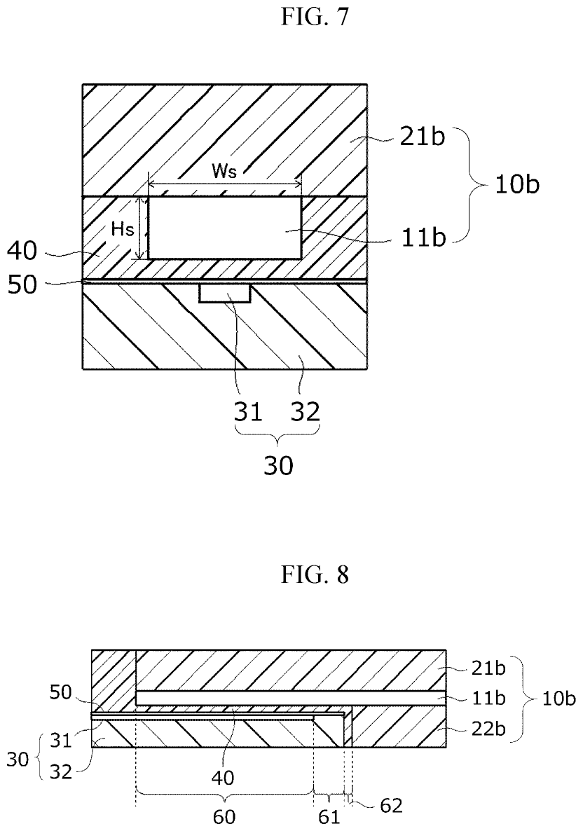

FIG. 7 and FIG. 8 are schematic vertical cross-sectional view and schematic transverse cross-sectional view of the vicinity of the terminal end S of the core in the evaluation model used for simulation analysis regarding connection loss at the adiabatic connecting portion.

FIG. 7 illustrates an adiabatic connecting portion serving as a terminal end S of an optical waveguide 10b. Therefore, in the optical waveguide 10b provided in the adiabatic connecting portion, a core 11b and an under-cladding portion 21b as the cladding portion are illustrated as regions where the core is not entirely covered. As illustrated in FIG. 8, an optical waveguide portion of the optical waveguide 10b includes an exposed region in which the core 11b is in contact with the under-cladding portion 21b and is not covered with the over-cladding portion, and a region in which the core 11b is covered with the under-cladding portion 21b and an over-cladding portion 22b.

As illustrated in FIG. 7, a silicon optical waveguide 30 provided in the adiabatic connecting portion includes a core 31 and a cladding portion 32.

As illustrated in FIG. 8, the optical waveguide 10b and the silicon optical waveguide 30 are disposed such that the core 11b of the optical waveguide 10b and the core 31 of the silicon optical waveguide 30 face each other, and are joined to each other with an adhesive 40. A barrier layer 50 is formed on a surface of the silicon optical waveguide 30 on an adhesive 40 side.

The structure of the evaluation model is as follows.
Optical waveguide 10b
   Core 11b (closer to the terminal end S)
Core width Ws: 5.0 μm
Core height Hs: 2.1 μm
Refractive index: 1.53
Length of adiabatic coupling portion 60: 1750 μm
   Cladding portion: under-cladding portion 21b
Thickness: 15 μm
Length: 3050 μm
Refractive index: 1.518
   Cladding portion: over-cladding portion 22b
Thickness: 15 μm
Length: 1000 μm
Refractive index: 1.518
Silicon optical waveguide 30
   Core 31
Width: a configuration in which a width is narrowed by a quadratic function from 0.35 μm to 0.07 μm from one end on an opposite side of the adiabatic coupling portion 60 to the other end of the adiabatic coupling portion 60
Height: 0.16 μm
Refractive index: 3.45
Length of adiabatic coupling portion 60: 1750 μm
   Cladding portion 32
Thickness: 15 μm
Refractive index: 1.45
Length of region 61 where only cladding portion 32 exists: 250 μm

### Adhesive 40

Resin thickness (distance between surfaces of the core 11b of the optical waveguide 10b and the core 31 of the silicon optical waveguide 30 facing each other): 0.5 μm
Refractive index: 1.51
Length of region 62 between silicon optical waveguide 30 and optical waveguide portion of optical waveguide 10b: 50 μm

### Barrier Layer 50

Thickness: 0.03 μm
Refractive index: 1.989

### (2. Optical Loss in Pitch Conversion Region)

The pitch conversion region in the evaluation model has the same configuration as that of Example 9. That is, the axis deviation amount at the joint X1 was −0.2 μm, the axis deviation amount at the inflection point X2 was 0.4 μm, and the axis deviation amount at the joint X3 was −0.2 μm.

### (3. Connection Loss of Single-Mode Connecting Portion)

The simulation analysis of connection loss at a single-mode connecting portion between an optical waveguide and a single-mode optical fiber, that is, at a butt connecting portion with a single-mode optical fiber was performed by the following evaluation model.

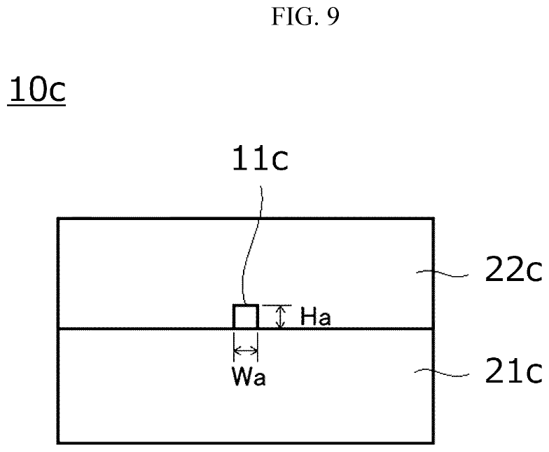

FIG. 9 is a schematic cross-sectional view illustrating the evaluation model of an optical waveguide 10c including a start end A of a core 11c used for simulation analysis of connection loss at the single-mode connecting portion. As illustrated in FIG. 9, the optical waveguide 10c is an optical waveguide of a portion corresponding to the linear region La in which the core 11c is covered by the under-cladding portion 21c and the over-cladding portion 22c which are cladding portions.

The structure of the evaluation model is as follows.
Optical waveguide 10c
   Core 11c (closer to start end A)
Core width Wa: 2.1 μm
Core height Ha: 2.1 μm
Refractive index: 1.53
Length: 3000 μm
   Cladding portion: under-cladding portion 21c
Thickness: 15 μm
Length: 3000 μm
Refractive index: 1.518
   Cladding portion: over-cladding portion 22c
Thickness: 15 μm
Length: 3000 μm
Refractive index: 1.518

### Single-Mode Optical Fiber

Core diameter: 8.2 μm
Core refractive index: 1.4698
Cladding refractive index: 1.4656

As a result of simulation analysis of the connection loss at the adiabatic connecting portion, the optical loss in the pitch conversion region, and the connection loss at the single-mode connecting portion, the connection loss at the adiabatic connecting portion was 0.27 dB in the TE mode and 0.56 dB in the TM mode. The optical loss in the pitch conversion region was 0.04 dB in the TE mode and 0.04 dB in the TM mode. The connection loss at the single-mode connecting portion was 0.44 dB in the TE mode and 0.44 dB in the TM mode. In other words, an optical waveguide can be obtained in which the total optical loss from the adiabatic connecting portion to the single-mode connecting portion is 0.75 dB in the TE mode and 1.04 dB in the TM mode.

### REFERENCE SIGNS LIST

1, 11a, 11b: core
2: cladding portion
21a, 21b: under-cladding portion
22a, 22b: over-cladding portion
10, 10a, 10b: optical waveguide
30: silicon optical waveguide
31: core
32: cladding portion
40: adhesive
50: barrier layer
A: start end
S: terminal end
C: curved region
La: linear region
Ls: linear region
X1: joint
X2: inflection point
X3: joint

What is claimed is:

1. An optical waveguide comprising two or more cores and a cladding portion, wherein
each of the cores is a continuous portion without branching from a start end to a terminal end in a propagation direction of light,
at least one of the cores includes a linear region and a curved region, and has an axis deviation at least at one of a joint between the linear region and the curved region and an inflection point of the curved region, and
the axis deviation occurs in a direction perpendicular to the propagation direction of light in a plan view.

2. The optical waveguide according to claim 1, wherein
the curved region includes a region having a minimum curvature of 15 mm or less.

3. The optical waveguide according to claim 1, wherein
the axis deviation has an absolute value of an axis deviation amount of 0.2 μm to 1 μm.

4. The optical waveguide according to claim 1, wherein
each of the cores has an absolute value of a total amount of axis deviation amount of the axial deviation of 1 μm or less.

5. The optical waveguide according to claim 1, wherein
at least two of the cores each include the linear region and the curved region and have an axis deviation at least at one of the joint between the linear region and the curved region and the inflection point of the curved region, and
the axis deviation occurs in the direction perpendicular to the propagation direction of light in a plan view.

6. The optical waveguide according to claim 1, wherein
a pitch is defined as a distance between one core and an adjacent core,
the cores have the pitch different at the start end and the terminal end,
the difference in the pitch is formed by a pitch conversion region in the core,
the pitch conversion region includes the curved region, and
the pitch conversion region has a core width (Wp) of 2 μm to 8 μm.

7. The optical waveguide according to claim 6, wherein
the pitch conversion region has a ratio (Hp/Wp) of a core height (Hp) to the core width (Wp) of 1.0 or less.

8. The optical waveguide according to claim 1, wherein
the core has portions having different core widths along the propagation direction of light.

9. The optical waveguide according to claim 1, wherein
the core has different core widths at the start end and the terminal end.

10. The optical waveguide according to claim 1, wherein
the core has a portion a where a core width is the smallest and the portion a has a core height (Ha) of 1.3 μm to 4.5 μm.

11. The optical waveguide according to claim 1, wherein
the core has a portion a where a core width is the smallest and the portion a has a ratio (Ha/Wa) of a core height (Ha) to a core width (Wa) being 1.25 or less.

12. The optical waveguide according to claim 1, wherein
the core further includes an exposed coupling portion, and the exposed coupling portion is a region of the core including at least one of the start end and the terminal end.

13. The optical waveguide according to claim 1, wherein
the optical waveguide includes four or more of the cores,
a pitch is defined as a distance between one core and an adjacent core, and
in all the cores, a difference between a maximum value and a minimum value of the pitch is 2 μm or less at the start end.

14. The optical waveguide according to claim 1, wherein
the optical waveguide includes four or more of the cores,
a pitch is defined as a distance between one core and an adjacent core, and
in all of the cores, a difference between a maximum value and a minimum value of the pitch is 2 μm or less at the terminal end.

15. The optical waveguide according to claim 1, wherein
a pitch is defined as a distance between one core and an adjacent core, and
the pitch is 8 μm to 500 μm at least at one of the start end and the terminal end.

16. An optical integrated device, comprising the optical waveguide as described in claim 1 and a semi-conductor substrate connected to the optical waveguide, wherein
light propagated in a single mode is introduced into the semi-conductor substrate via the core of the optical waveguide.
